(19) United States
(12) Patent Application Publication
(10) Pub. No.: US 2017/0293478 A1
(43) Pub. Date: Oct. 12, 2017

(54) Fire detection system with automatic firmware updating

(71) Applicant: Tyco Fire & Security GmbH, Neuhausen am Rheinfall (CH)

(72) Inventors: Robert W. Farley, Ashburnham, MA (US); James Ogier, Shirley, MA (US); Shachak Zaarur, Brookline, MA (US)

(21) Appl. No.: 15/095,680

(22) Filed: Apr. 11, 2016

(51) Int. Cl. G06F 9/445

(52) U.S. Cl. CPC G06F 8/65; G08B 17/00

(57) ABSTRACT

A system and method for updating the firmware of slave units in a fire system detects whether a new slave unit has been installed and compares the version of the firmware in the newly-installed slave unit with that of previously-installed slave units of the same type (including any backup copies of firmware stored by the master module in a file system). If the newly-installed slave unit's firmware is more recent, any backup copies of the firmware stored by the master module are replaced with an image of the new version of the firmware. Additionally, slave units with older versions of the firmware are updated to the newest version.

### RELATED APPLICATIONS

This application is related to U.S. application Ser. No. ______, filed on an even date herewith, entitled “Fire detection system with distributed file system”, attorney docket number 0324.0010US1/F-FD-00146US, now U.S. Patent Publication No.: ______, and U.S. application Ser. No. ______, filed on an even date herewith, entitled “Addressing method for slave units in fire detection system”, attorney docket number 0324.0012US1/F-FD-00144US, now U.S. Patent Publication No.: ______, both of which are incorporated herein by reference in their entirety.

### BACKGROUND OF THE INVENTION

Fire systems, such as fire detection systems, fire suppression systems or combination fire detection and suppression systems, typically comprise a master module and a series of slave units. Slave units have elements that are designed to perform specific tasks related to fire detection, notification, and suppression, such as detecting information about the environment and communicating the information to the master module, or, upon receiving instructions from the master module, performing a fire suppression function or generating an audible and/or visual alert to occupants.

Different types of slave units or combinations of slave units are typically deployed based on the specific application. Fire systems for premises typically include fire sensors, pull stations, and alarms. On the other hand, fire systems for vehicles typically include a variety of sensors, release modules, annunciators, and manual override switches.

Fire systems are installed on large vehicles such as those used in the mining, forestry, landfill and mass transit industries to prevent or mitigate damage to complex and. expensive equipment. For example, a mining dump truck could feature a reciprocating engine driving a generator, which in turn provides power to electric motors that drive the wheels. Any one of these components can overheat and catch on fire, causing extensive damage to complex and expensive equipment. The fire systems are employed to minimize such losses.

The master modules and slave units of fire systems are typically installed on a common bus. Each of these modules and units will typically include micro controllers, nonvolatile memory (for example, flash memory) and transceivers for communicating on the bus. Master modules send instructions to and receive information from slave units through their respective transceivers. Within each module or unit, the microcontrollers execute firmware instructions stored in memory.

### SUMMARY OF THE INVENTION

As the operational lifetimes of the fire systems are often measured in decades, new versions of modules' firmware are typically released throughout the systems' lifetimes. New firmware is installed to fix bugs, improve performance, or enable compatibility with new devices. Some systems require using portable computers or other tools to update firmware. Another approach is to enable the fire systems to read firmware updates from memory sticks via ports on the systems. In these cases, the firmware on the slave units is updated with the firmware stored on the memory sticks. In some systems, images of the firmware for slave units can be saved by the master module and used to replace the slave units' firmware if they become corrupted or if they are outdated.

Throughout the lifetime of fire systems, it is not uncommon for new slave units to be installed, for example, to replace an old, malfunctioning slave unit. In another example, a new slave unit could be installed in addition to existing slave units to expand the capabilities of the fire system.

The problem that these situations present is that newly installed slave units could have been manufactured well before or well after the manufacture of the slave units previously installed on the system. For example, a spare slave unit that is several years old but unused could be installed, or a brand new slave unit could be purchased and installed on a system with previously-installed slave units that are several years old. This could result in different versions of slave unit firmware simultaneously operating on the same system. Moreover, not all units may have the most up-to-date firmware.

In general, according to one aspect, the invention features a method for updating the firmware of slave units. This method comprises determining a version of the firmware for a newly-installed slave unit and updating the firmware of the newly-installed slave unit or the previously-installed slave units based on the version of the firmware of the newly-installed slave unit.

In embodiments, the master module might update the firmware of the newly-installed slave unit if a more-recent version of the firmware is present on the previously-installed slave units of the same type as the newly-installed slave unit and/or is accessible to master module. A stored firmware image file can further be updated with the firmware of the newly-installed slave unit if a more-recent version of the firmware is present on the newly-installed slave unit.

In one example, the master module updates the firmware of the previously-installed slave units of the same type as the newly-installed slave unit if a more-recent version of the firmware is present on the newly-installed slave units.

Typically, the master module reads and validates the firmware image read from the newly-installed slave unit. In a current example, the master module first updates a firmware image file with the firmware of the newly-installed slave unit if a more-recent version of the firmware is present on the newly-installed slave unit; and then the master module updates the firmware of the previously-installed slave units of the same type as the newly-installed slave unit based on the updated firmware image file.

This method can be applied to fire systems installed on vehicles.

In general, according to another aspect, the invention features a fire system comprising slave units and a master module determining a version of the firmware for a newly-installed slave unit and updating the firmware of the newly-installed slave unit or previously-installed slave units based on the version of the firmware of the newly-installed slave unit.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a block diagram of a fire system installed on a vehicle, for example;

FIG. 2A is a schematic diagram of a generic slave unit;

FIG. 2B is a schematic diagram of a master module;

FIG. 2C is a schematic diagram of a battery unit;

FIG. 2D is a schematic diagram of a display unit;

FIG. 3 is a flow diagram illustrating the method for updating firmware of older modules from a newer found version;

FIG. 4 is a diagram of the memory for each of a master module, a battery unit, a display unit, and two fire sensor units installed on a fire system;

FIG. 5 is a diagram of a device index stored on the master nonvolatile memory;

FIG. 6 illustrates the read slave memory location instruction;

FIG. 7 illustrates the memory data response packet;

FIG. 8 illustrates the memory for each of the master module, the battery unit, the display unit, and the two fire sensor units installed on the fire system, after the corresponding older version of the backup copy of the firmware has been erased.

FIG. 9 illustrates the memory for each of the master module, the battery unit, the display unit, and the two fire sensor units installed on the fire system, after the backup copy of the fire sensor unit firmware (v4) has been stored in the file system;

FIG. 10 illustrates the memory for each of the master module, the battery unit, the display unit, and the two fire sensor units installed on the fire system, after the previously-installed fire sensor unit is updated with the new firmware; and

FIG. 11 illustrates the device index after it has been updated.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

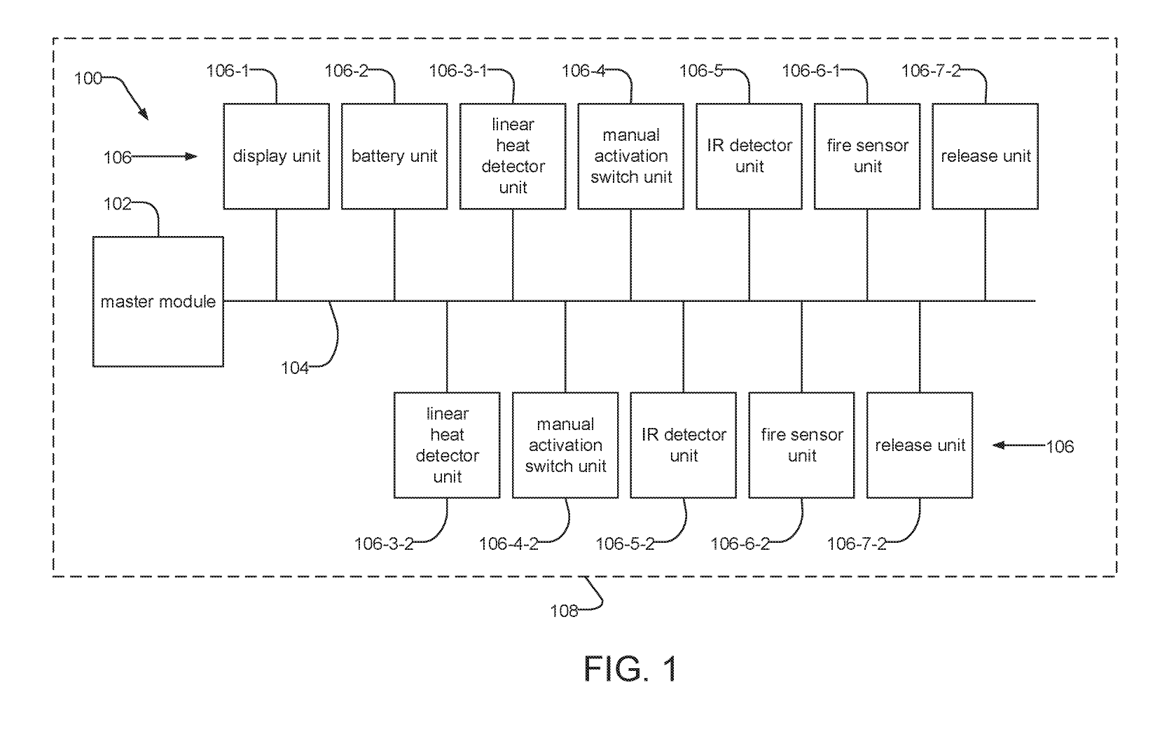

FIG. 1 is a block diagram of a fire system 100, such as a fire detection system, a fire suppression system or a combination fire detection and suppression system, installed on a vehicle 108, for example, to which the present invention is applicable.

The system comprises a master module 102 and a series of slave units 106 installed on a common bus 104. The master module 102 sends instructions to and receives information from the slave units 106, and the slave units 106 receive instructions from the master module 102 and send information (for example, information about the environment detected by a slave unit 106) to the master module 102.

The data bus 104 is preferably common from a logical perspective. The master module 102 preferably uses a common address space to communicate with the various slave units 106 using the data bus 104. That said, the bus 104 is currently implemented as several physical data buses/wiring interfaces (ports) on the master module 102. This helps to ensure proper and repeatable installation by having specific units be connected to specific wiring interfaces or ports on the master module 102.

In the illustrated example, the installed slave units include a display unit 106-1, which displays information about the state of the fire system 100, a battery unit 106-2, which supplies power to the fire system 100, two linear heat detector units 106-3, which detect heat and communicate information to the master module 102, two manual activation switch units 106-4, which, when activated by an operator (for example, a driver of the vehicle) trigger a fire suppression function, two IR detector units 106-5, which detect infrared radiation and communicate information to the master module 102, two fire sensor units 106-6, which detect the presence of fire and communicate information to the master module 102, and two release units 106-7, which perform a fire suppression function.

In one example, the fire sensor 106-6 could detect that a fire is present and send the information to the master module 102. The master module 102, in turn, could then send instructions to the release module 106-7 to perform a fire suppression function, and/or instructions to the display 106-1 to display an alert.

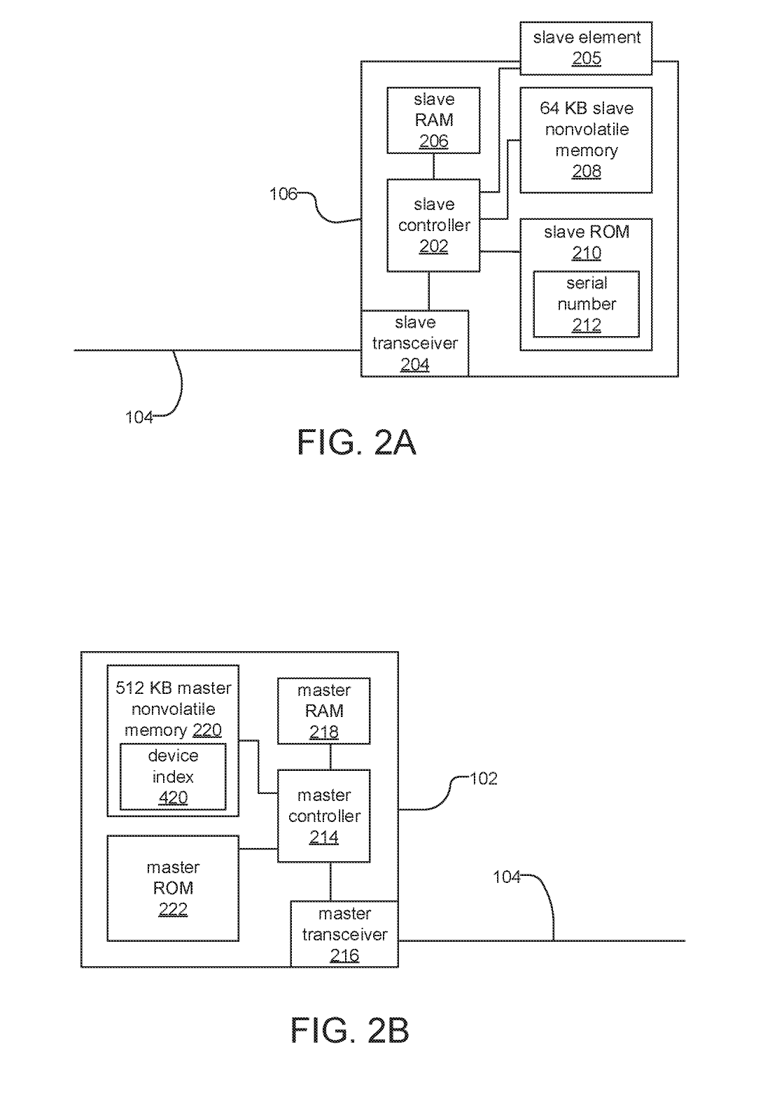

FIGS. 2A-2D are schematic diagrams of various units of the fire system 100. Each unit similarly includes a controller 202, 214, 228, 244, a transceiver 204, 216, 230, 246, volatile random access memory (RAM) 206, 218, 232, 248, nonvolatile memory 208, 220, 236, 252, and ROM 210, 222, 238, 254. Each unit 106, 102, 106-2, 106-1 connects to the common bus 104 through its transceiver 204, 216, 230, 246. The controllers 202, 214, 228, 244 execute firmware instructions stored on the nonvolatile memory 208, 220, 236, 252. In addition to firmware, the nonvolatile memory of each unit also stores data associated with maintaining state.

FIG. 2A is a schematic diagram of a generic slave unit 106. Examples include fire sensor units 106-6. Each of the slave units typically includes a slave element 205, which is typically different for each type of slave. For example for a smoke detector slave unit, the slave element 205 is a smoke sensor that detects smoke, with the slave controller monitoring the detected smoke levels by the element and communicating those levels to the master module. In another example, for a fire detector slave unit, the slave element 205 might be a thermistor that detects ambient temperature with the slave controller monitoring the detected temperature levels and communicating those levels to the master module or triggering an alarm condition itself. In the case of a release unit, the slave element 205 might be a relay that controls the release of fire suppressant. The slave controller in this case waits for a release instruction from the master module 102 and then operates the relay accordingly.

FIG. 2B is a schematic diagram of the master module 102. In addition to firmware and data associated with maintaining state, the master nonvolatile memory 220 also stores file metadata 224.

FIG. 2C is a schematic diagram of a battery unit 106-2, which is a particular type of slave unit 106 that supplies power to the fire system 100. The battery control unit 234 performs the functions of a battery management system (e.g. preventing the battery from operating outside its Safe Operating Area, monitoring its state, etc.). The battery 240 provides electrical power to the fire system 100.

FIG. 2D is a schematic diagram of a display unit 106-1, which is a particular type of slave unit 106 that displays information about the state of the fire system 100. The display driver unit 250 renders information to be displayed on the display 256. The USB port 258 receives data from external memory and communicates the information to the display controller 244. The memory stick 259 is an example of external memory, and is a portable device with nonvolatile memory (for example, flash memory) and a USB output. The memory stick 259 could contain, for example, updates to slave firmware.

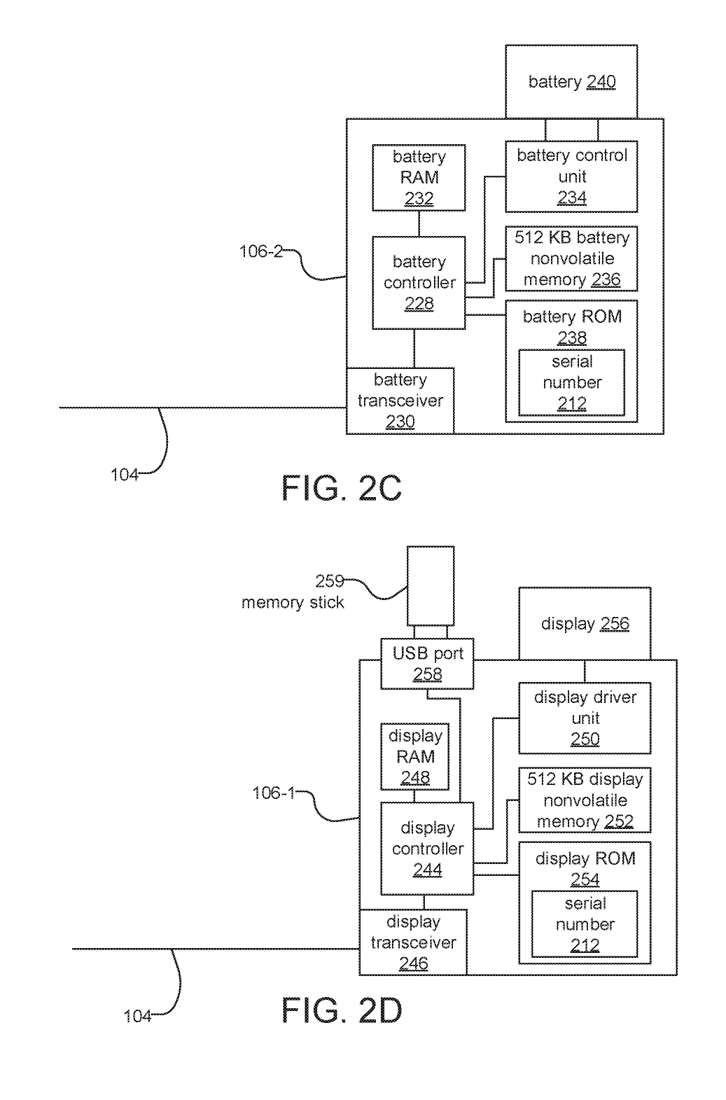

FIG. 3 is a flow diagram illustrating the method for updating firmware of older modules from a newer found version.

In step 302, it is determined or detected whether a new slave unit has been installed on the fire system 100.

In one example, a new fire sensor unit 106-6 is newly installed on a fire system 100 on which a battery unit 106-2, a display unit 106-1, and a fire sensor unit 106-6 were previously installed.

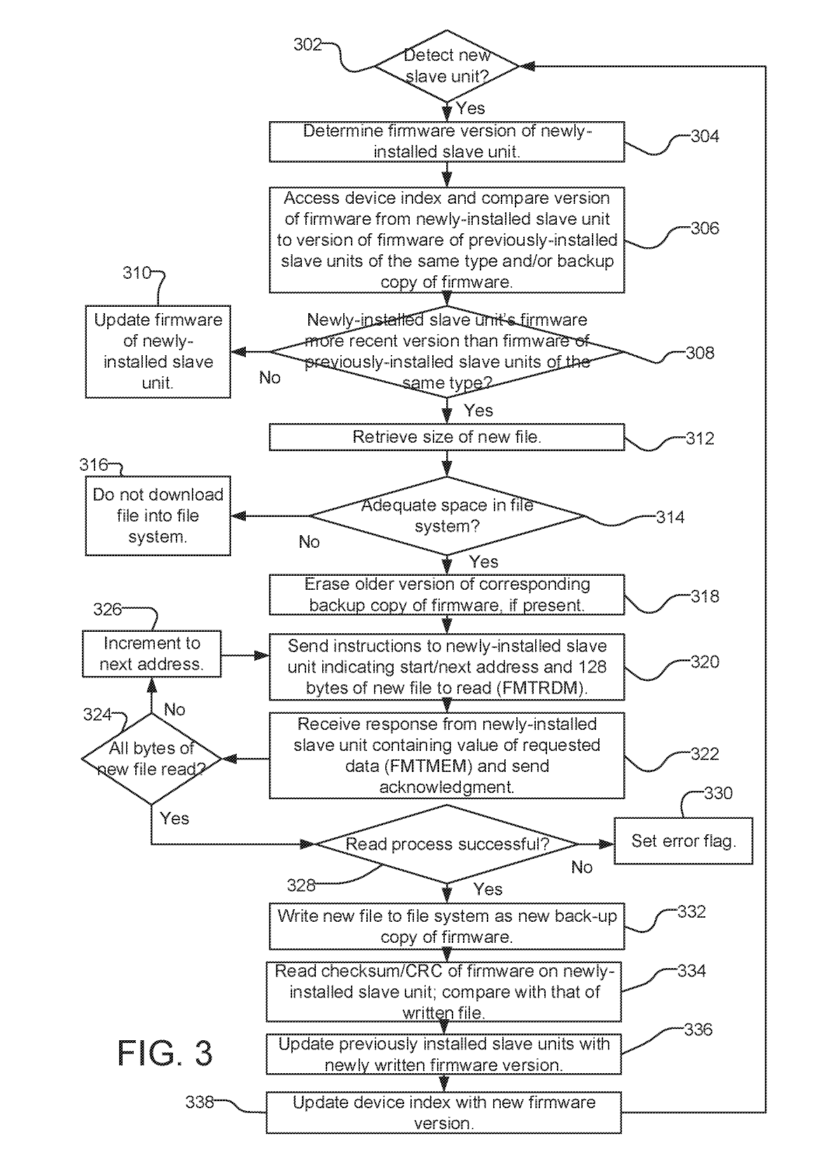

Illustrating this example, FIG. 4 is a diagram of the memory for each of the master module 102, the battery unit 106-2, the display unit 106-1, and the two fire sensor units 106-6. Included are a master nonvolatile memory 220, battery nonvolatile memory 236, display nonvolatile memory 252, and fire sensor unit nonvolatile memory 208. The first fire sensor unit nonvolatile memory 208-1 pertains to the previously-installed fire sensor unit 106-6, while the second fire sensor unit nonvolatile memory 208-2 pertains to a newly-installed fire sensor unit 106-6. In the illustrated example, the master nonvolatile memory 220 includes master module firmware 402, the battery nonvolatile memory 236 includes battery unit firmware (v2) 404, which is version two of the firmware for battery units, the display module nonvolatile memory 252 includes display unit firmware (v5) 406, the previously-installed first fire sensor unit nonvolatile memory 208-1 includes fire sensor unit firmware (v3) 408, and the newly-installed fire sensor unit nonvolatile memory 208-2 includes fire sensor unit firmware (v4) 410.

In addition to firmware, the master nonvolatile memory 220 includes a file system 412, which is a system of files maintained by the master module 102. In the preferred embodiment, the file system 412 is a distributed file system such as that described in related U.S. application Ser. No. ______, entitled “Fire detection system with distributed file system”. In the illustrated embodiment, the file system 412 is stored, for example, on the master nonvolatile memory 220. The file system 412 includes a battery unit firmware (v2) image 414, which is a backup copy of version two of the firmware for battery units, a display unit firmware (v5) image 416, and a fire sensor unit firmware (v3) image 418, Also included on the master nonvolatile memory 220 is a device index 420.

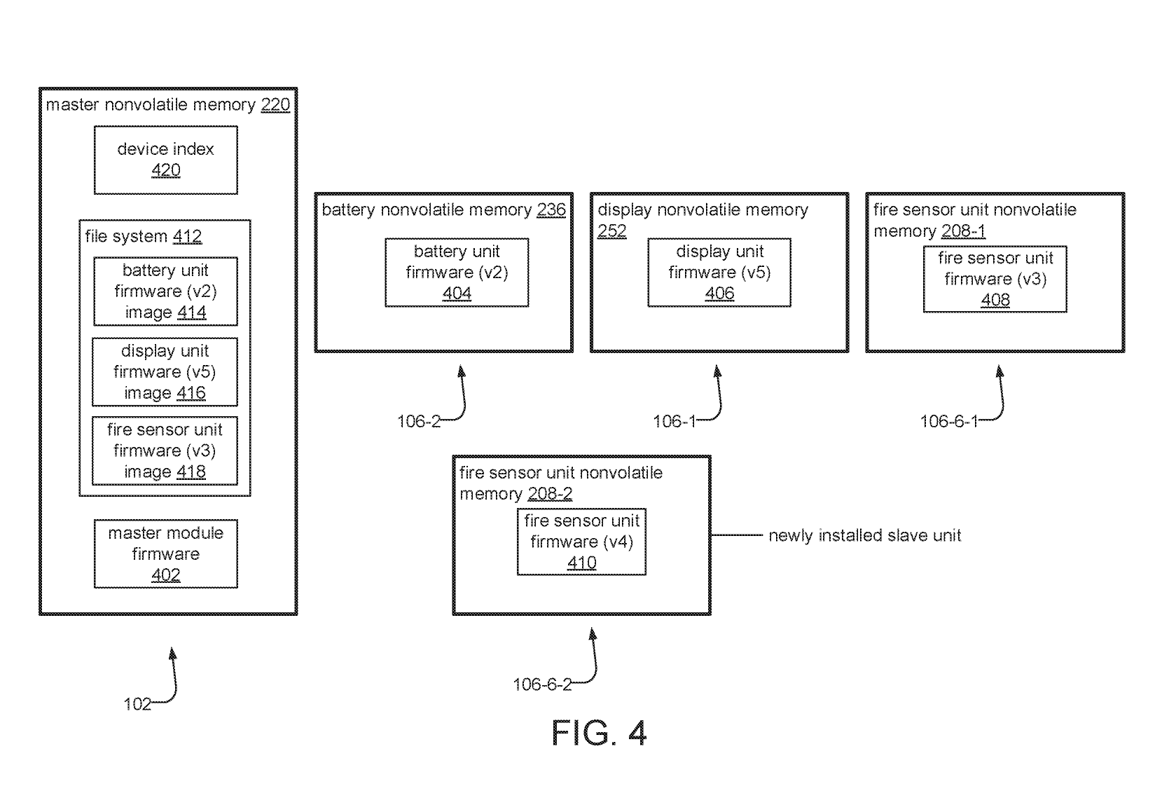

FIG. 5 is a diagram of the device index 420 stored on the master nonvolatile memory 220. The device index 420 includes information about the various modules installed on the fire system 100, including a device address, which is a unique address assigned to each installed module, a serial number, which is a unique number assigned to each module when the module is manufactured, the type of module and the version of the firmware of the module. For example, the battery unit 106-2 has a device address of “1”, a serial number of “0100”, a module type of “battery”, and a firmware version of two.

Returning to FIG. 3, once a newly-installed slave unit is detected, in step 304 the firmware version of the newly-installed slave unit is determined. In step 306, the device index 420 is accessed to determine the version of the firmware for any previously-installed slave units of the same type and/or the backup copy of the firmware stored by the master module 102. It is then determined whether the newly-installed slave unit's firmware is a more recent version than the firmware of the previously-installed slave units of the same type in step 308. In step 312, the size of the firmware of the newly-installed slave unit is determined. In step 314, it is determined whether there is adequate space in the file system 412. If not, in step 316, the new file is not downloaded into the file system 412. If, on the other hand, there is adequate space, in step 318, the older version of the corresponding file backup is erased.

Steps 320 through 328 illustrate the process for the master module 102 reading the firmware from a slave unit 106. The firmware is read from the slave nonvolatile memory 208, 236, 252 using a series of instructions sent between the master module 102 and the slave unit 106.

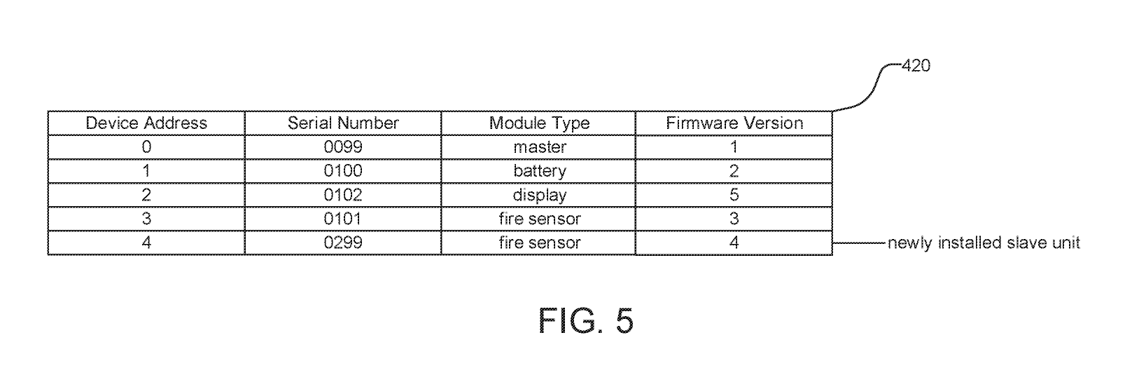

FIG. 6 illustrates the read slave memory location instruction 502, which is sent by the master module 102 to the newly-installed slave unit 106. The read slave memory location instruction 502 includes a header with a format code, the high byte of the most significant word of the start address, the low byte of the most significant word of the start address, the high byte of the least significant word of the start address, the low byte of the least significant word of the start address, and the number of bytes to read.

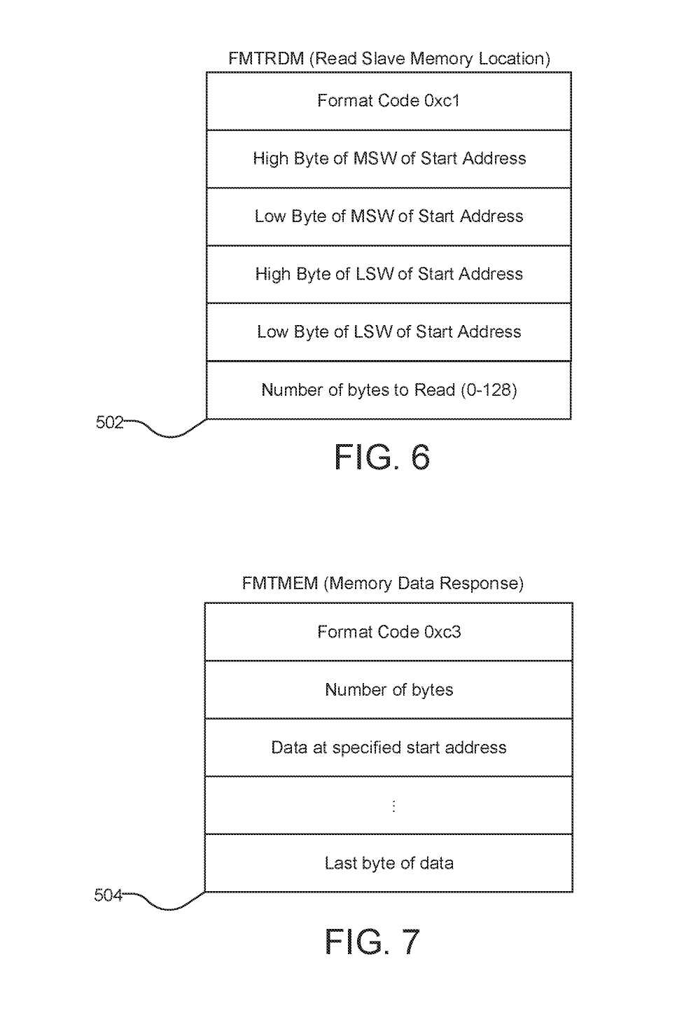

FIG. 7 illustrates the memory data response packet 504, which is sent from the newly-installed slave unit 106 to the master module 102 in response to the read slave memory location instruction 502. The memory data response packet 512 includes a header with a format code, the number of bytes of data included, and the data starting at the start address indicated in the read slave memory location instruction 502 and ending after the number of bytes indicated in the read slave memory location instruction 502 is included.

Returning to FIG. 3, the master module 102 sends a read slave memory location instruction 502 to the newly-installed slave unit 106, indicating the start address, which is the address where the firmware of the slave unit 106 begins, and indicating that the first 128 bytes of the firmware should be read. In step 322, a memory data response packet 504 is received by the master module 102 from the slave unit 106, including the data at the start address. Then, in step 324, it is determined whether all of the bytes of the firmware of the slave unit 106 have been read. If so, the process proceeds to step 328. If not, in step 326, the address is then incremented to the next address, which is the address where the next 128 bytes of the firmware of the slave unit 106 begins. The process returns to step 320, at which point the next address is sent to the slave unit 106, and the next 128 bytes of the firmware is read.

When all of the bytes of the firmware of the newly-installed slave unit 106 have been read, in step 328 it is determined whether the read process was successful. This can be implemented using, among other methods, a checksum or CRC value, which is a value calculated from a portion of data used to verify the integrity of the data. If the read process was not successful, an error flag is set in step 330.

If the read process was successful, on the other hand, in step 332, the firmware image read from the newly-installed slave unit 106 is then stored in the file system 412 as a new backup copy of firmware, in one embodiment.

In step 334, the checksum/CRC of the firmware image newly-written to the file system 412 is then read and compared with that of the firmware of the newly-installed slave unit 106.

Then, in step 336, previously-installed slave units 106 of the same type as the newly-installed slave unit 106 are updated with the newly written firmware image stored on the file system 412.

Finally, in step 338, the device index 420 is updated with the new firmware version of any updated slave units 106.

In the illustrated example, the fire sensor unit 106-6-2 is detected by the master module 102 as a newly-installed slave unit. It is then determined that the fire sensor unit firmware (v4) 410 installed on the newly-installed fire sensor unit nonvolatile memory 208-2 is version four of the fire sensor unit firmware. The file index 420 is then accessed, and it is determined that a previously-installed fire sensor unit 106-6 exists with a firmware version of three. It is also determined that the backup copy of the fire sensor firmware stored by the master module 102, which is the fire sensor unit firmware (v3) image 418, is also version three. Because the firmware version of the newly-installed fire sensor unit 106-6 (four) is more recent than that of the previously-installed fire sensor unit 106-6 (three) and the backup copy (three), it is determined that firmware for the previously-installed fire sensor units, and the corresponding backup copy, should be updated. It is then determined that there is adequate space on the file system 412, so the fire sensor unit firmware (v3) image 418 is erased.

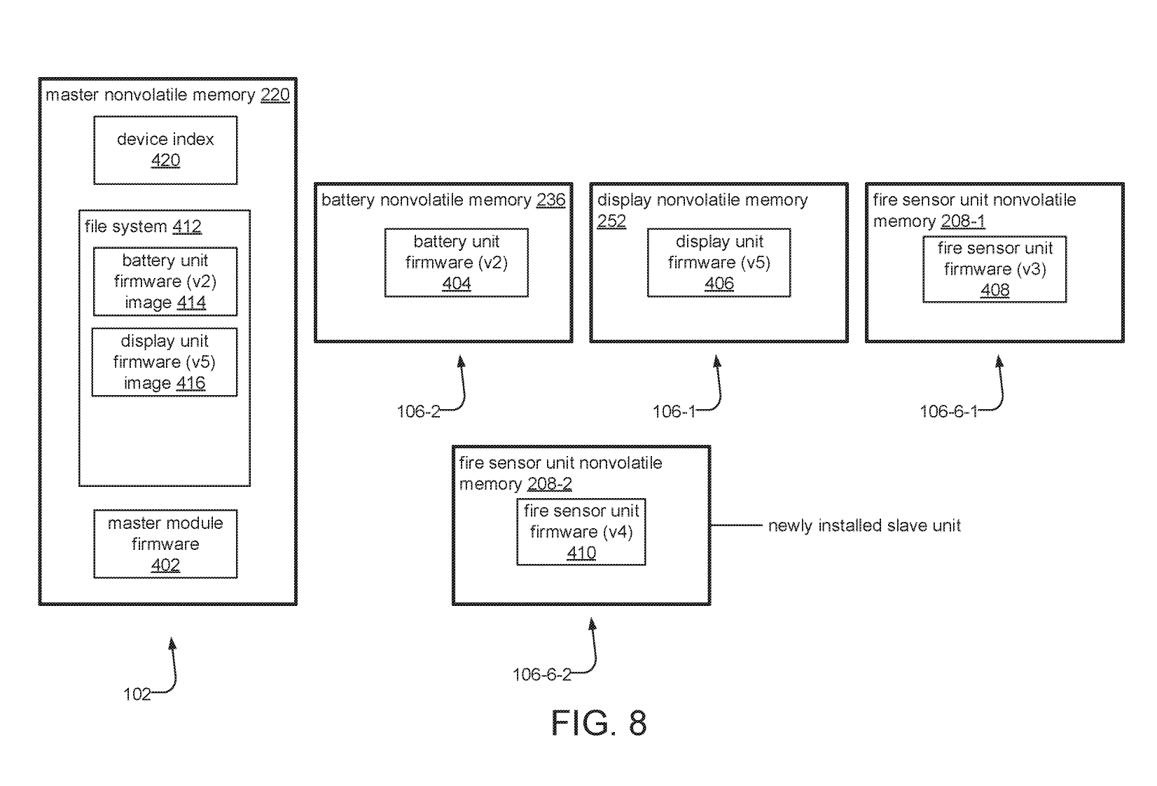

FIG. 8 illustrates the memory for each of the master module 102, the battery unit 106-2, the display unit 106-1, and the two fire sensor units 106-6 installed on the fire system 100 after the corresponding older version of the backup copy of the firmware has been erased. In the illustrated example, the fire sensor unit firmware (v3) image 418 is no longer stored in the file system 412 on the master nonvolatile memory 220.

The fire sensor unit firmware (v4) 410 is then read from the fire sensor unit nonvolatile memory 208-2. of the newly-installed fire sensor unit 106-6 and stored as a backup in the file system 412.

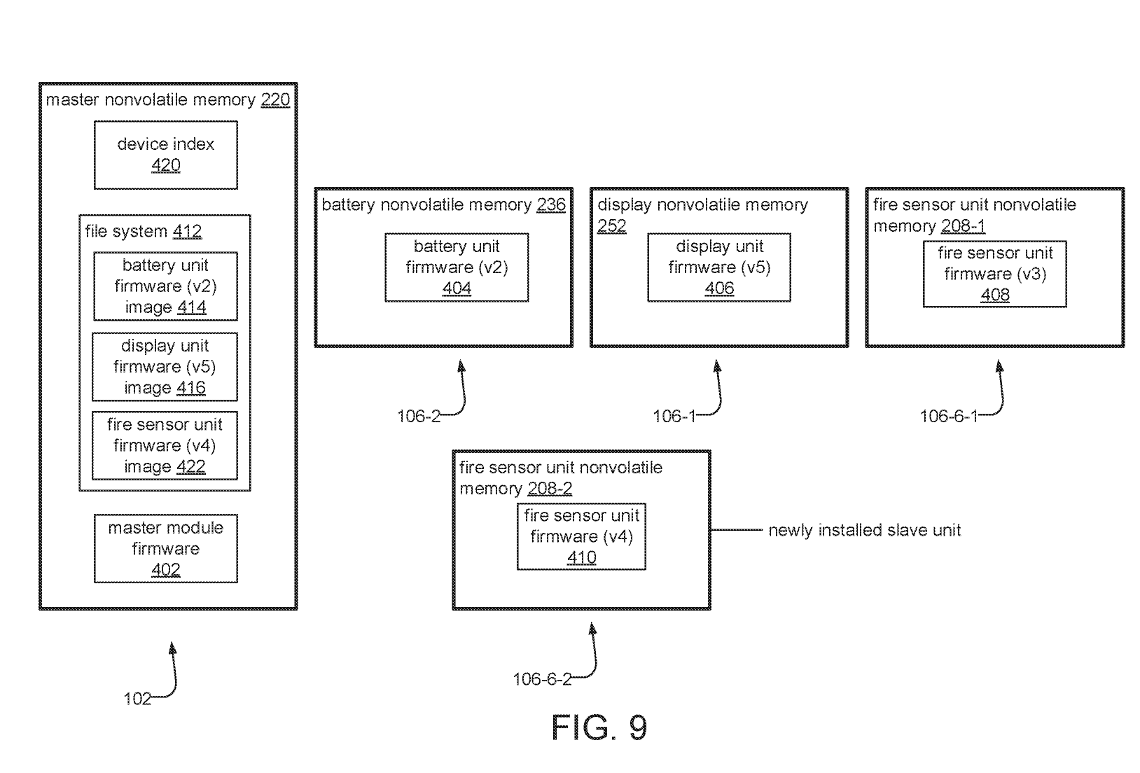

FIG. 9 illustrates the memory for each of the master module 102, the battery unit 106-2, the display unit 106-1, and the two fire sensor units 106-6 installed on the fire system 100, after the backup copy of the fire sensor unit firmware (v4) 410 has been stored in the file system 412. The file system 412 now contains a fire sensor unit firmware (v4) image 422.

The previously installed fire sensor unit 106-6, containing the older version of the firmware, is then updated with the new firmware.

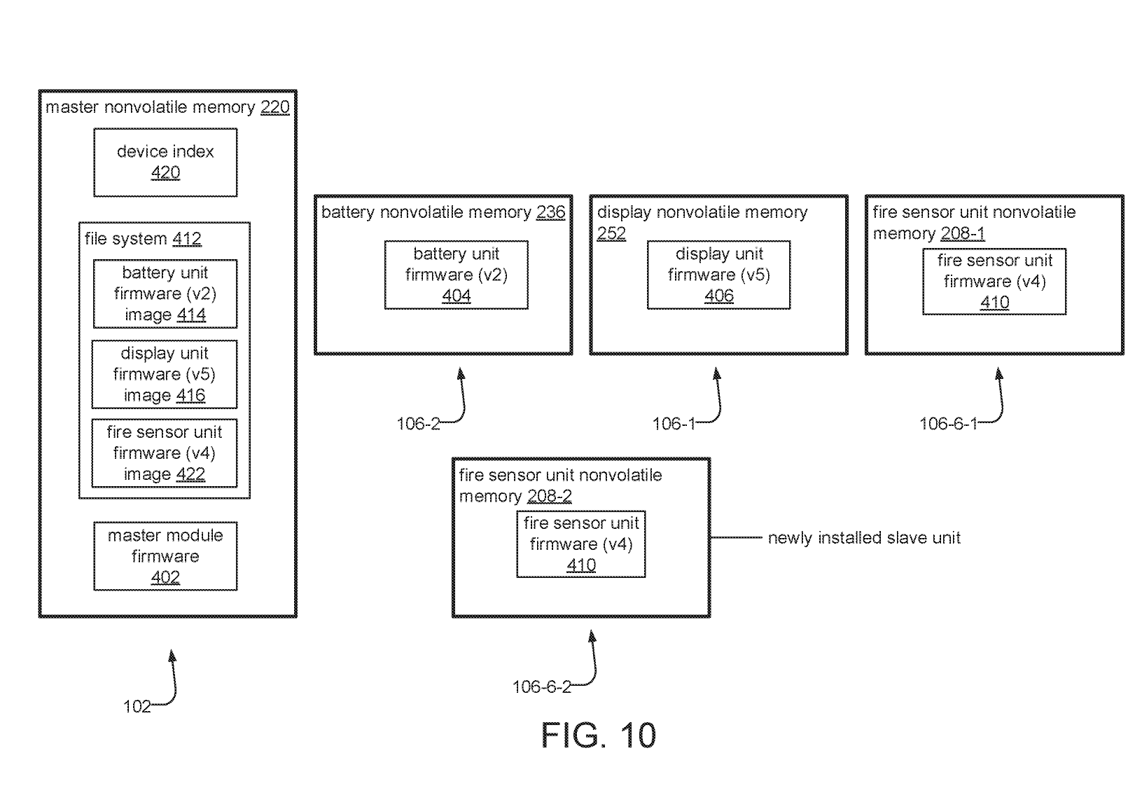

FIG. 10 illustrates the memory for each of the master module 102, the battery unit 106-2, the display unit 106-1, and the two fire sensor units 106-6 installed on the fire system 100, after the previously-installed fire sensor unit 106-6 is updated with the new firmware. The fire sensor unit nonvolatile memory 208-1 now contains the fire sensor unit firmware (v4) 410.

Finally, the device index 420 is updated.

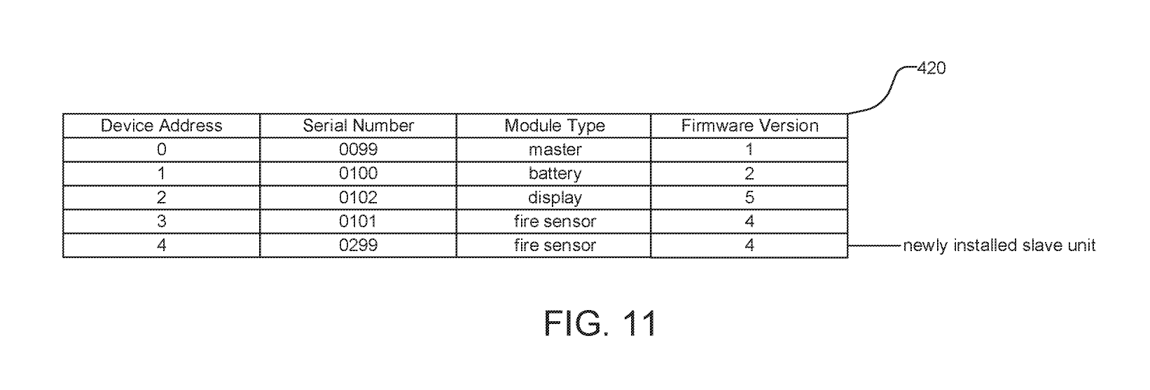

FIG. 11 illustrates the device index 420, after it has been updated. The previously-installed fire sensor unit 106-6 (with device address 3 and serial number 0101) is now listed as having firmware version four.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for updating firmware of slave units in a fire system, the method comprising:
a master module determining a version of the firmware for a newly-installed slave unit; and
the master module updating the firmware of the newly-installed slave unit or previously-installed slave units based on the version of the firmware of the newly-installed slave unit.

2. The method as claimed in claim 1, wherein the master module updates the firmware of the newly-installed slave unit if a more-recent version of the firmware is present on the previously-installed slave units of the same type as the newly-installed slave unit.

3. The method as claimed in claim 1, wherein the master module updates the firmware of the newly-installed slave unit if a more-recent version of the firmware is accessible to master module.

4. The method as claimed in claim 1, wherein the master module updates a firmware image file with the firmware of the newly-installed slave unit if a more-recent version of the firmware is present on the newly-installed slave unit.

5. The method as claimed in claim 1, wherein the master module updates the firmware of the previously-installed slave units of the same type as the newly-installed slave unit if a more-recent version of the firmware is present on the newly-installed slave units.

6. The method as claimed in claim 5, wherein the master module reads and validates the firmware image read from the newly-installed slave unit.

7. The method as claimed in claim 1, wherein the master module first updates a firmware image file with the firmware of the newly-installed slave unit if a more-recent version of the firmware is present on the newly-installed slave unit; and then the master module updates the firmware of the previously-installed slave units of the same type as the newly-installed slave unit based on the updated firmware image file.

8. The method as claimed in claim 1, wherein the fire system is installed on a vehicle.

9. A fire system, comprising:
slave units of the fire system;
a master module determining a version of the firmware for a newly-installed slave unit and updating the firmware of the newly-installed slave unit or previously-installed slave units based on the version of the firmware of the newly-installed slave unit.

10. The system as claimed in claim 9, wherein the master module updates the firmware of the newly-installed slave unit if a more-recent version of the firmware is present on the previously-installed slave units of the same type as the newly-installed slave unit.

11. The system as claimed in claim 9, wherein the master module updates the firmware of the newly-installed slave unit if a more-recent version of the firmware is accessible to master module.

12. The system as claimed in claim 9, wherein the master module updates a firmware image file with the firmware of the newly-installed slave unit if a more-recent version of the firmware is present on the newly-installed slave unit.

13. The system as claimed in claim 9, wherein the master module updates the firmware of the previously-installed slave units of the same type as the newly-installed slave unit if a more-recent version of the firmware is present on the newly-installed slave units.

14. The system as claimed in claim 9, wherein the master module reads and validates the firmware image read from the newly-installed slave unit.

15. The system as claimed in claim 9, wherein the master module first updates a firmware image file with the firmware of the newly-installed slave unit if a more-recent version of the firmware is present on the newly-installed slave unit; and then the master module updates the firmware of the previously-installed slave units of the same type as the newly-installed slave unit based on the updated firmware image file.

16. The system as claimed in claim 9, wherein the fire detection system is installed on a vehicle.
